(19) United States
(12) Patent Application Publication
(10) Pub. No.: US 2011/0221415 A1
(43) Pub. Date: Sep. 15, 2011

(54) DC/DC CONVERTER

(75) Inventors: Masafumi Otsuka, Kanagawa (JP); Yoichi Tokai, Tokyo (JP); Ryo Tanifuji, Kanagawa (JP)

(73) Assignee: KABUSHIKI KAISHA TOSHIBA, Tokyo (JP)

(21) Appl. No.: 13/041,600

(22) Filed: Mar. 7, 2011

(30) Foreign Application Priority Data
Mar. 9, 2010 (JP) 2010-052051

(51) Int. Cl. G05F 1/618

(52) U.S. Cl. 323/283

(57) ABSTRACT

According to one embodiment, a switching transistor changes, based on ON/OFF operations, the direction of an electric current flowing to an inductor. A gate driving unit applies a driving voltage to a gate of the switching transistor. A power-supply switching unit switches, based on a result of comparison of the input voltage and the output voltage, the voltage of a power supply that generates the driving voltage.

### CROSS-REFERENCE TO RELATED APPLICATIONS

This application is based upon and claims the benefit of priority from the prior Japanese Patent Application No. 2010-52051, filed on Mar. 9, 2010; the entire contents of which are incorporated herein by reference.

### FIELD

Embodiments described herein relate generally to a DC/DC converter.

### BACKGROUND

A boost type DC/DC converter superimposes energy, which is accumulated in an inductor according to ON/OFF operations of a switching transistor, on an input voltage to perform boosting. If the boost type DC/DC converter is started in a state in which the input voltage is higher than an output voltage, it is likely that a rush current flows to the inductor to cause a drop in the input voltage or break a power supply. Therefore, a current-limiting transistor is connected in series to the inductor to limit the rush current that flows when the boost type DC/DC converter is started.

In this method, because an electric current flowing to the inductor always flows to the current-limiting transistor as well, in some case, a loss equivalent to ON resistance of the current-limiting transistor occurs and the efficiency of the boost type DC/DC converter falls.

There is also a method of turning off a third MOS transistor and turning on a fourth MOS transistor during a boosting operation to suppress a current leak from an output terminal side to an input terminal side due to a parasitic diode of a second MOS transistor, turning on the third MOS transistor and turning off the fourth MOS transistor in a boosting stop state to suppress a current leak from the input terminal side to the output terminal side due to the parasitic diode of the second MOS transistor and, when the boosting operation is started from the boosting stop state, before switching a substrate bias state of the second MOS transistor, charging an electrode on the output terminal side of the second MOS transistor to prevent a rush current from flowing from the input terminal side to the output terminal side via the parasitic diode of the second MOS transistor.

In this method, because it is necessary to supply a driving voltage for driving a gate of the second MOS transistor from a battery, the gate of the second MOS transistor is driven at a voltage lower than a boosted voltage. Therefore, in some case, the ON resistance of the second MOS transistor cannot be sufficiently reduced during boosting and the efficiency of a DC/DC converter falls.

### BRIEF DESCRIPTION OF THE DRAWINGS

FIG. 1 is a block diagram of a schematic configuration of a DC/DC converter according to a first embodiment;

FIG. 2 is a block diagram of a schematic configuration of a DC/DC converter according to a second embodiment;

FIG. 3 is a block diagram of a schematic configuration of a DC/DC converter according to a third embodiment;

FIG. 4 is a block diagram of a schematic configuration of a DC/DC converter according to a fourth embodiment;

FIG. 5 is a diagram of a change in an output voltage Vout during the start of the DC/DC converter shown in FIG. 4;

FIG. 6 is a diagram of waveforms of the output voltage Vout and an inductor current IL during the start of the DC/DC converter shown in FIG. 4 without a current source; and

FIG. 7 is a diagram of waveforms of the output voltage Vout and the inductor current IL during the start of the DC/DC converter shown in FIG. 4.

### DETAILED DESCRIPTION

In general, according to one embodiment, a DC/DC converter that converts an input voltage into an output voltage includes: a switching transistor, a gate driving unit, and a power-supply switching unit. The switching transistor changes, based on ON/OFF operations, the direction of an electric current flowing to an inductor. The gate driving unit applies a driving voltage to a gate of the switching transistor. The power-supply switching unit switches, based on a result of comparison of the input voltage and the output voltage, the voltage of a power supply that generates the driving voltage.

Exemplary embodiments of a DC/DC converter will be explained below in detail with reference to the accompanying drawings. The present invention is not limited to the following embodiments.

### First Embodiment

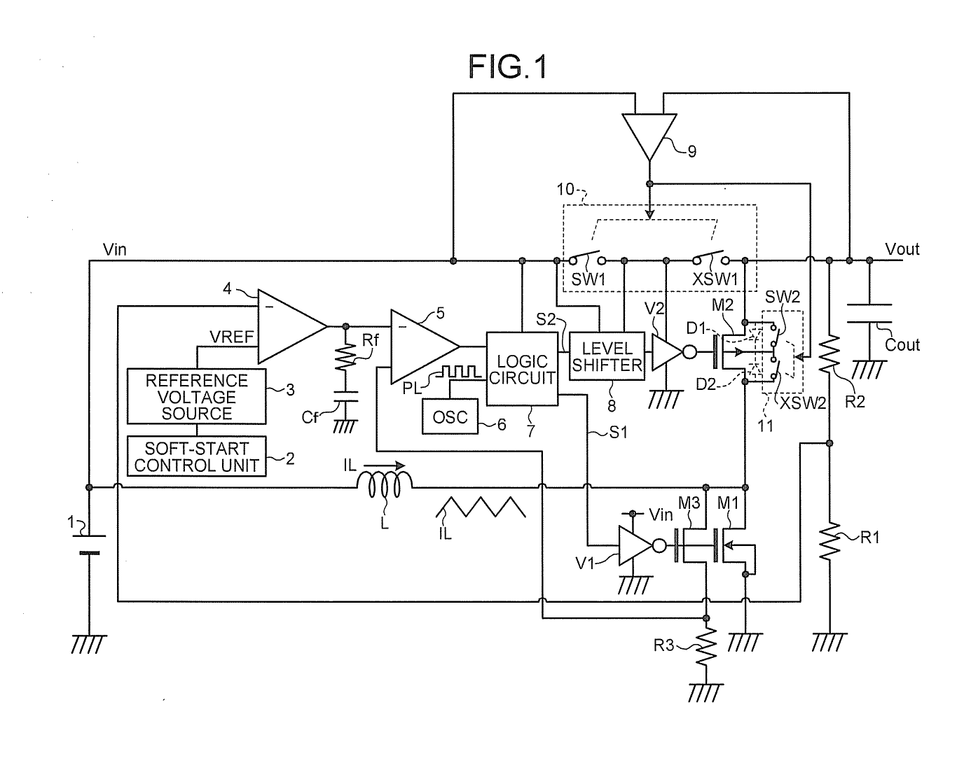

FIG. 1 is a block diagram of a schematic configuration of a DC/DC converter according to a first embodiment.

In FIG. 1, the DC/DC converter includes resistors R1 and R2 that divide an output voltage Vout, a reference voltage source 3 that generates a reference voltage VREF, an error amplifier 4 that outputs an error signal corresponding to a difference between a divided value of the output voltage Vout and the reference voltage VREF, a comparator 5 that compares a detected value of an inductor current IL flowing to an inductor L and the error signal, an oscillator 6 that generates a pulse signal PL, a logic circuit 7 that switches, based on an output from the comparator 5, ON and OFF of switching transistors M1 and M2 in synchronization with the pulse signal PL, a level shifter 8 that shifts a level of a signal output from the logic circuit 7 to a gate of the switching transistor M2, inverters V1 and V2 that respectively drive the switching transistors M1 and M2 based on an output of the logic circuit 7, a current detection transistor M3 that detects the inductor current IL, and a resistor R3 that converts an electric current flowing to the current detection transistor M3 into a voltage.

A P-channel field effect transistor can be used as the switching transistor M2. An N-channel field effect transistor can be used as the switching transistor M1. The switching transistors M1 and M2 are connected in series to each other. A source of the switching transistor M2 is connected to an output side of the output voltage Vout. A source of the switching transistor M1 is connected to a ground side. A back gate of the switching transistor M1 is usually connected to the source side of the switching transistor M1. In a state in which a switch SW2 is on and a switch XSW2 is off, a parasitic diode D1 is formed between a back gate and the source of the switching transistor M2. In a state in which the switch SW2 is off and the switch XSW2 is on, a parasitic diode D2 is formed between the back gate and a drain of the switching transistor M2.

Because the current detection transistor M3 and the switching transistor M1 form a current mirror, the current detection transistor M3 can detect the inductor current IL. To reduce the influence of the current detection transistor M3 on the inductor current IL, for example, an electric current flowing to the current detection transistor M3 can be set to 1/100 of an electric current flowing to the switching transistor M1.

The logic circuit 7 can cause the switching transistors M1 and M2 to operate in a complementary manner each other. Specifically, the logic circuit 7 can turn off the switching transistor M2 when the logic circuit 7 turns on the switching transistor M1. The logic circuit 7 can turn on the switching transistor M2 when the logic circuit 7 turns off the switching transistor M1.

A series circuit of a capacitor Cf and a resistor Rf is connected to an output terminal of the error amplifier 4. The series circuit of the capacitor Cf and the resistor Rf can operate as a filter that performs phase compensation.

The DC/DC converter further includes a soft-start control unit 2 that controls the reference voltage VREF during the start of the DC/DC converter to control a rising edge of the output voltage Vout, a comparator 9 that compares an input voltage Vin and the output voltage Vout, a power-supply switching unit 10 that switches, based on a result of the comparison of the input voltage Vin and the output voltage Vout, the voltage of a power supply for the level shifter 8 and the inverter V2, and a back-gate switching unit 11 that switches, based on the result of the comparison of the input voltage Vin and the output voltage Vout, connection of the back gate of the switching transistor M2 to the source side or the drain side. As a power supply for the inverter V1, the input voltage Vin can be used.

The power-supply switching unit 10 includes a switch SW1 that switches the power supply for the level shifter 8 and the inverter V2 to the input voltage Vin side and a switch XSW1 that switches the power supply for the level shifter 8 and the inverter V2 to the output voltage Vout side.

The back-gate switching unit 11 includes the switch SW2 that switches the connection of the back gate of the switching transistor M2 to the source side and the switch XSW2 that switches the connection of the back gate of the switching transistor M2 to the drain side.

One end of the inductor L is connected to a connection point of the switching transistors M1 and M2. The other end of the inductor L is connected to a DC power supply 1. A capacitor Cout that stores the output voltage Vout is connected to the output side of the output voltage Vout.

If it is assumed that charges are not accumulated in the capacitor Cout during the start of the DC/DC converter, the output voltage Vout is 0 and the input voltage Vin is larger than the output voltage Vout.

The comparator 9 compares the input voltage Vin and the output voltage Vout. When the input voltage Vin is larger than the output voltage Vout, the switches SW1 and XSW2 are turned on and the switches SW2 and XSW2 are turned off. When the switch SW1 is turned on and the switch XSW1 is turned off, the input voltage Vin is supplied to the power supply for the level shifter 8 and the inverter V2. When the switch XSW2 is turned on and the switch SW2 is turned off, the back gate of the switching transistor M2 is connected to the drain side.

During the start of the DC/DC converter, the soft-start control unit 2 controls the reference voltage VREF to gradually rise and inputs the reference voltage VREF to one input terminal of the error amplifier 4. The output resistors R1 and R2 divide the output voltage Vout and input a divided value of the output voltage Vout to the other input terminal of the error amplifier 4. The error amplifier 4 compares the divided value of the output voltage Vout and the reference voltage VREF. An error signal corresponding to a difference between the divided value and the reference voltage VREF is input to one input terminal of the comparator 5. The current detection transistor M3 detects the inductor current IL. After the resistor R3 converts the inductor current IL into a voltage, the voltage is input to the other input terminal of the comparator 5.

The comparator 5 compares a detected value of the inductor current IL and the error signal and inputs a result of the comparison to the logic circuit 7. When the detected value of the inductor current IL is smaller than the error signal, the logic circuit 7 sets a level of a gate control signal S1 to extend an ON duty of the switching transistor M1 and sets a level of a gate control signal S1 to reduce an OFF duty of the switching transistor M2.

After the inverter V1 inverts the gate control signal S1 output from the logic circuit 7, the gate control signal S1 is input to a gate of the switching transistor M1 and a gate of the current detection transistor M3. The switching transistor M1 and the current detection transistor M3 are turned off.

After the level shifter 8 level-shifts the gate control signal S2 output from the logic circuit 7, the inverter V2 inverts the gate control signal S2. The gate control signal S2 is input to the gate of the switching transistor M2. The switching transistor M2 is turned off.

When the switching transistor M1 is turned on and the switching transistor M2 is turned off, the inductor current IL gradually increases and energy is accumulated in the inductor L. When the detected value of the inductor current IL increases to be larger than the error signal, the logic circuit 7 sets the level of the gate control signal S1 to turn off the switching transistor M1. The logic circuit 7 sets the level of the gate control signal S2 to turn on the switching transistor M2.

When the switching transistor M1 is turned off and the switching transistor M2 is turned on, the inductor current IL gradually decreases. The energy accumulated in the inductor L is superimposed on the input voltage Vin. The output voltage Vout is controlled such that the divided value of the output voltage Vout approaches the reference voltage VREF.

When the input voltage Vin is larger than the output voltage Vout, the switch SW is turned off and the switch XSW2 is turned on to connect the back gate of the switching transistor M2 to the drain side. This makes it possible to prevent the inductor current IL from rushing into the capacitor Cout via the parasitic diode D2 when the switching transistor M2 is off. Therefore, it is unnecessary to connect a current limiting transistor in series to the inductor L to suppress a rush current during the start. It is possible to prevent a drop in the input voltage Vin from being caused and prevent the DC power supply 1 from being broken while suppressing a fall in the efficiency of the DC/DC converter.

When the input voltage Vin is larger than the output voltage Vout, the power supply for the level shifter 8 and the inverter V2 is switched to the input voltage Vin side. This makes it possible to set the gate potential of the switching transistor M2 at a level of the input voltage Vin larger than the output voltage Vout. Therefore, it is possible to reduce the ON resistance of the switching transistor M2 and improve the efficiency of the DC/DC converter.

When the output voltage Vout rises to be larger than the input voltage Vin, the switches SW1 and XSW2 are turned off and the switches SW2 and XSW1 are turned on. When the switch SW1 is turned off and the switch XSW1 is turned on, the output voltage Vout is supplied to the power supply for the level shifter 8 and the inverter V2. When the switch XSW2 is turned off and the switch SW2 is turned on, the back gate of the switching transistor M2 is connected to the source side.

The error amplifier 4 compares a divided value of the output voltage Vout and the reference voltage VREF and inputs an error signal corresponding to a difference between the divided value and the reference voltage VREF to one input terminal of the comparator 5. The current detection transistor M3 detects the inductor current IL. After the resistor R3 converts the inductor current IL into a voltage, the voltage is input to the other input terminal of the comparator 5.

The logic circuit 7 switches, based on the output from the comparator 5, ON and OFF of the switching transistors M1 and M2 in a complementary manner. Consequently, while the inductor current IL is increased and reduced in a triangular wave shape, the output voltage Vout is controlled such that the divided value of the output voltage Vout approaches the reference voltage VREF.

When the output voltage Vout is larger than the input voltage Vin, the back gate of the switching transistor M2 is connected to the source side. This makes it possible to prevent the inductor current IL from flowing backward.

When the output voltage Vout is larger than the input voltage Vin, the power supply for the level shifter 8 and the inverter V2 is switched to the output voltage Vout side. This makes it possible to set the gate potential of the switching transistor M2 at a level of the output voltage Vout larger than the input voltage Vin. Therefore, it is possible to reduce the ON resistance of the switching transistor M2 and improve the efficiency of the DC/DC converter.

### Second Embodiment

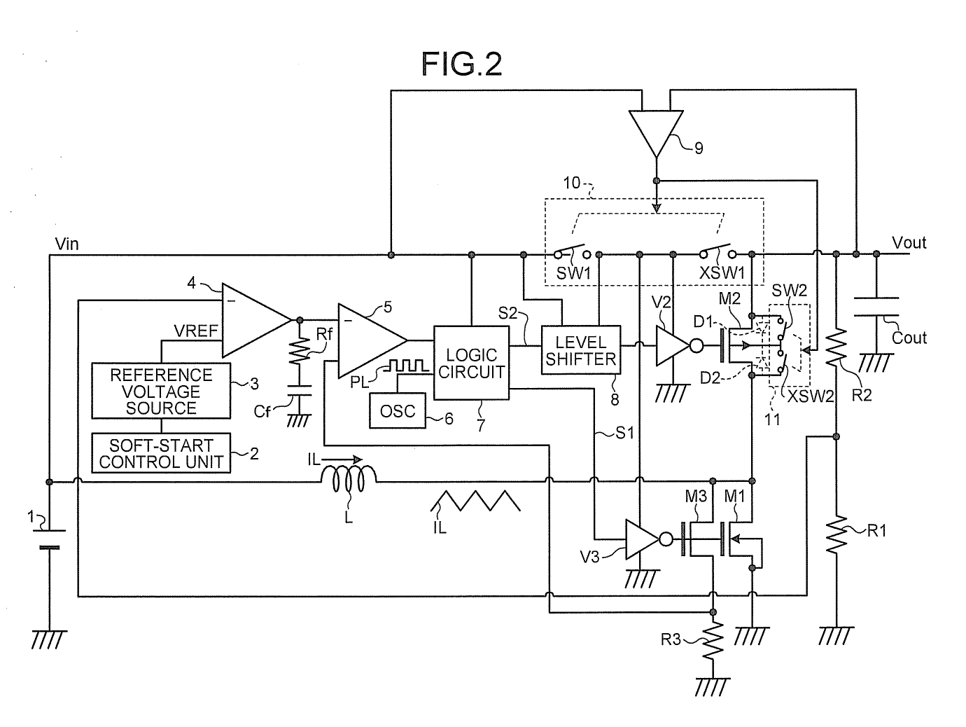

FIG. 2 is a block diagram of a schematic configuration of a DC/DC converter according to a second embodiment.

In FIG. 2, the DC/DC converter includes an inverter V3 instead of the inverter V1 shown in FIG. 1 to drive the switching transistor M1. Whereas the power supply is given at the input voltage Vin in the inverter V1, in the inverter V3 shown in FIG. 2, as in the inverter V2, the voltage of a power supply is switched based on a result of comparison of the input voltage Vin and the output voltage Vout. Specifically, when the input voltage Vin is larger than the output voltage Vout, the input voltage Vin is supplied to the power supply for the inverter V3. When the output voltage Vout is larger than the input voltage Vin, the output voltage Vout is supplied to the power supply for the inverter V3.

This makes it possible to set the gate potential of the switching transistor M1 at a level of a larger one of the input voltage Vin and the output voltage Vout. Therefore, it is possible to reduce the ON resistance of the switching transistor M1 and improve the efficiency of the DC/DC converter.

### Third Embodiment

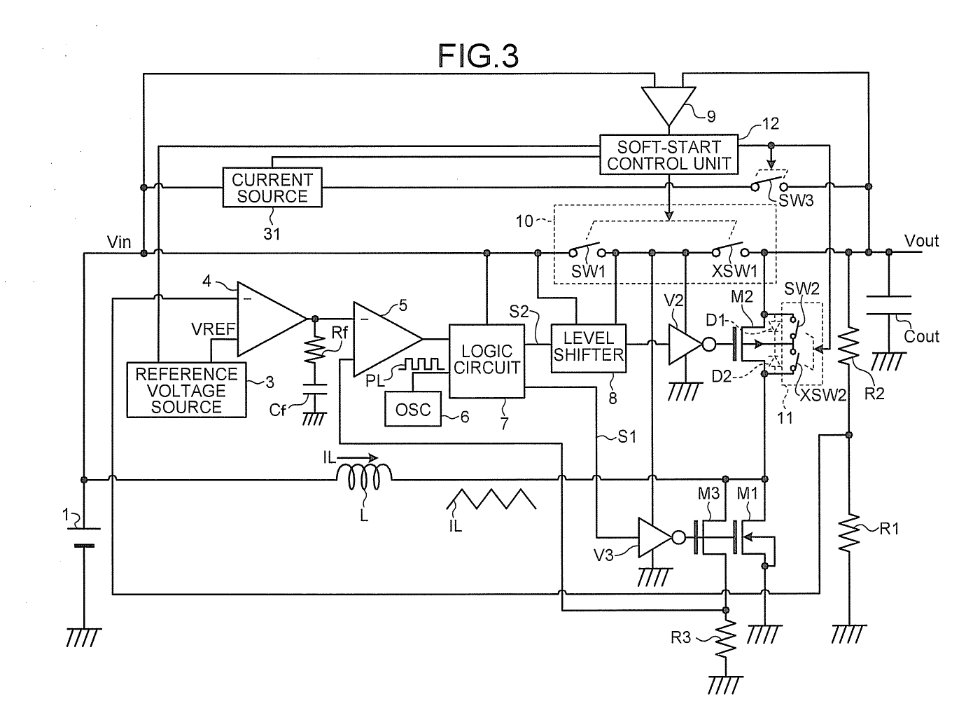

FIG. 3 is a block diagram of a schematic configuration of a DC/DC converter according to a third embodiment.

In FIG. 3, the DC/DC converter includes a current source 31, a soft-start control unit 12, and a switch SW3 instead of the soft-start control unit 2 of the DC/DC converter shown in FIG. 2. The current source 31 is connected to the capacitor Cout and can charge the capacitor Cout. The switch SW3 can disconnect the current source 31 and the capacitor Cout based on a result of comparison of the input voltage Vin and the output voltage Vout and stops the charging of the capacitor Cout by the current source 31. The soft-start control unit 12 can control a rising edge of the output voltage Vout by controlling the reference voltage VREF based on the result of the comparison of the input voltage Vin and the output voltage Vout.

The comparator 9 compares the input voltage Vin and the output voltage Vout and inputs a result of the comparison to the soft-start control unit 12. When the input voltage Vin is larger than the output voltage Vout, the soft-start control unit 12 turns on the switches SW1, XSW2, and SW3 and turns off the switches SW2 and XSW1. When the switch SW3 is turned on, the capacitor Cout is charged by the current source 31 and the output voltage Vout gradually rises.

When the output voltage Vout rises to be equal to or larger than the input voltage Vin, the switches SW1, XSW2, and SW3 are turned off and the switches SW2 and XSW1 are turned on. The soft-start control unit 12 controls the reference voltage VREF to gradually rise. The logic circuit 7 switches, based on the output from the comparator 5, ON and OFF of the switching transistors M1 and M2 in a complementary manner. Consequently, while the inductor current IL is increased and reduced in a triangular wave shape, the output voltage Vout is controlled such that the divided value of the output voltage Vout approaches the reference voltage VREF.

When the input voltage Vin is larger than the output voltage Vout, the capacitor Cout is charged by the current source 31 until the input voltage Vin becomes equal to the output voltage Vout. This makes it possible to raise the output voltage Vout without causing the switching transistors M1 and M2 to perform ON/OFF operations. Therefore, it is possible to easily and freely adjust time until the input voltage Vin and the output voltage Vout become equal and a limit value of a rush current.

### Fourth Embodiment

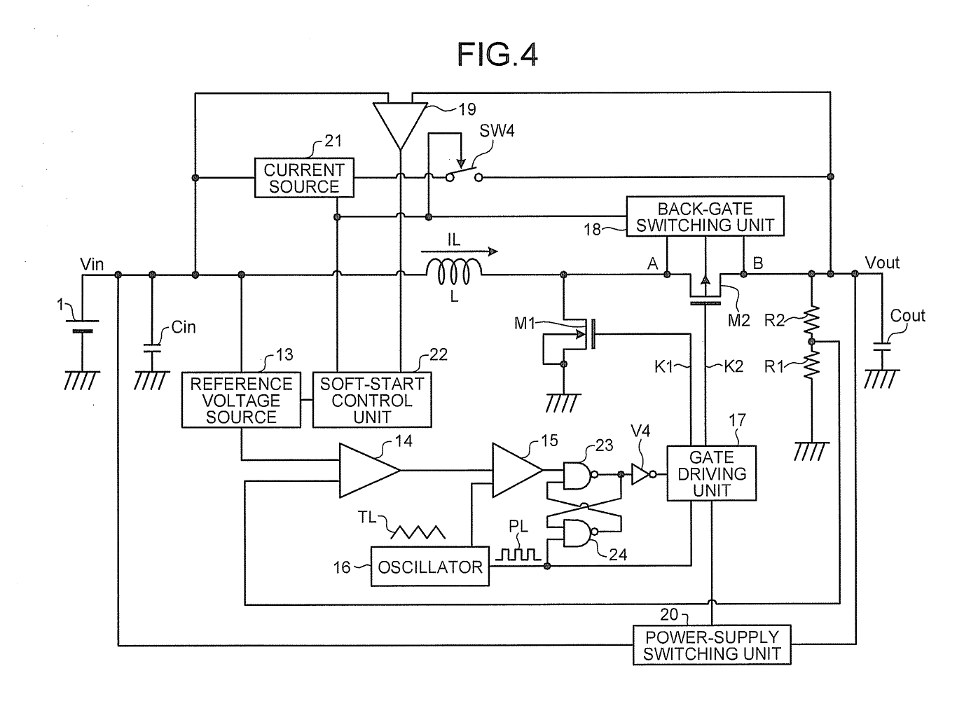

FIG. 4 is a block diagram of a schematic configuration of a DC/DC converter according to a fourth embodiment.

In FIG. 4, the DC/DC converter includes the resistors R1 and R2 that divide the output voltage Vout, a reference voltage source 13 that generates the reference voltage VREF, an error amplifier 14 that outputs an error signal corresponding to a difference between a divided value of the output voltage Vout and the reference voltage VREF, a comparator 15 that compares a triangular wave signal TL generated by an oscillator 16 and the error signal, the oscillator 16 that generates a pulse signal PL and the triangular wave signal TL, a gate driving unit 17 that drives the gates of the switching transistors M1 and M2 based on a result of the comparison by the comparator 15, NAND circuits 23 and 24 that store the result of the comparison by the comparator 15, and an inverter V4 that inverts an output of the NAND circuit 23. An output terminal of one of the NAND circuits 23 and 24 is connected to an input terminal of the other to form a flip flop.

The gate driving unit 17 can cause the switching transistors M1 and M2 to operate in a complementary manner each other. When the gate driving unit 17 turns on the switching transistor M1, the gate driving unit 17 can turn off the switching transistor M2. When the gate driving unit 17 turns off the switching transistor M1, the gate driving unit 17 can turn on the switching transistor M2.

The DC/DC converter further includes a soft-start control unit 22 that controls the reference voltage VREF based on a result of comparison of the input voltage Vin and the output voltage Vout to control a rising edge of the output voltage Vout, a comparator 19 that compares the input voltage Vin and the output voltage Vout, a power-supply switching unit 20 that switches, based on the result of the comparison of the input voltage Vin and the output voltage Vout, the voltage of a power supply for the gate driving unit 17, a back-gate switching unit 18 that switches, based on the result of the comparison of the input voltage Vin and the output voltage Vout, connection of the back gate of the switching transistor M2 to the source side or the drain side, a current source 21 that charges the capacitor Cout, and a switch SW4 that stops, based on the result of the comparison of the input voltage Vin and the output voltage Vout, the charging of the capacitor Cout by the current source 21.

One end of the inductor L is connected to the connection point of the switching transistors M1 and M2. The other end of the inductor L is connected to the DC power supply 1. The capacitor Cout that stores the output voltage Vout is connected to the output side of the output voltage Vout. A capacitor Cin that stores the input voltage Vin is connected to an input side of the input voltage Vin.

The comparator 19 compares the input voltage Vin and the output voltage Vout and inputs a result of the comparison to the soft-start control unit 22. When the input voltage Vin is larger than the output voltage Vout, the switch SW4 is turned on, the back-gate switching unit 18 connects the back gate of the switching transistor M2 to the drain side, and the power-supply switching unit 20 switches the power supply for the gate driving unit 17 to the input voltage Vin side. When the switch SW4 is turned on, the capacitor Cout is charged by the current source 21 and the output voltage Vout gradually rises.

When the output voltage Vout rises to be equal to or larger than the input voltage Vin, the switch SW4 is turned off, the back-gate switching unit 18 connects the back gate of the switching transistor M2 to the source side, and the power-supply switching unit 20 switches the power supply for the gate driving unit 17 to the output voltage Vout side. The soft-start control unit 22 controls the reference voltage VREF to gradually rise and inputs the reference voltage VREF to one input terminal of the error amplifier 14. The resistors R1 and R2 divide the output voltage Vout. A divided value of the output voltage Vout is input to the other input terminal of the error amplifier 14. The error amplifier 14 compares the divided value of the output voltage Vout and the reference voltage VREF. An error signal corresponding to a difference between the divided value and the reference voltage VREF is input to one input terminal of the comparator 15. The triangular wave signal TL generated by the oscillator 16 is input to the other input terminal of the comparator 15.

The comparator 15 compares the triangular wave signal TL and the error signal. A result of the comparison is stored in the NAND circuits 23 and 24 according to the pulse signal PL and input to the gate driving unit 17 via the inverter V4. When the triangular wave signal TL is smaller than the error signal, the gate driving unit 17 sets a level of a driving signal K1 to turn on the switching transistor M1 and sets a level of a driving signal K2 to turn off the switching transistor M2.

The driving signal K1 output from the gate driving unit 17 is input to the gate of the switching transistor M1. The switching transistor M1 is turned on. The driving signal K2 output from the gate driving unit 17 is input to the gate of the switching transistor M2. The switching transistor M2 is turned off.

When the switching transistor M1 is turned on and the switching transistor M2 is turned off, the inductor current IL gradually increases and energy is accumulated in the inductor L. When the triangular wave signal TL increases to be larger than the error signal, the gate driving unit 17 sets a level of the driving signal K1 to turn off the switching transistor M1 and sets a level of the driving signal K2 to turn on the switching transistor M2.

When the switching transistor M1 is turned off and the switching transistor M2 is turned on, the inductor current IL gradually decreases, the energy accumulated in the inductor L is superimposed on the input voltage Vin, and the output voltage Vout is controlled such that the divided voltage of the output voltage Vout approaches the reference voltage VREF.

When the input voltage Vin is larger than the output voltage Vout, the capacitor Cout is charged by the current source 21 until the input voltage Vin becomes equal to the output voltage Vout. This makes it possible to raise the output voltage Vout without causing the switching transistors M1 and M2 to perform ON/OFF operations.

When the input voltage Vin is larger than the output voltage Vout, the back gate of the switching transistor M2 is connected to the drain side. This makes it possible to prevent the inductor current IL from rushing into the capacitor Cout via a parasitic diode when the switching transistor M2 is off. Therefore, it is unnecessary to connect a current limiting transistor in series to the inductor L to suppress a rush current during the start. It is possible to prevent a drop in the input voltage Vin from being caused and prevent the DC power supply 1 from being broken while suppressing a fall in the efficiency of the DC/DC converter.

The voltage of the power supply for the gate driving unit 17 is switched based on the result of the comparison of the input voltage Vin and the output voltage Vout. This makes it possible to set the gate potential of the switching transistors M1 and M2 at a level of a larger one of the input voltage Vin and the output voltage Vout. Therefore, it is possible to reduce the ON resistance of the switching transistors M1 and M2 and improve the efficiency of the DC/DC converter.

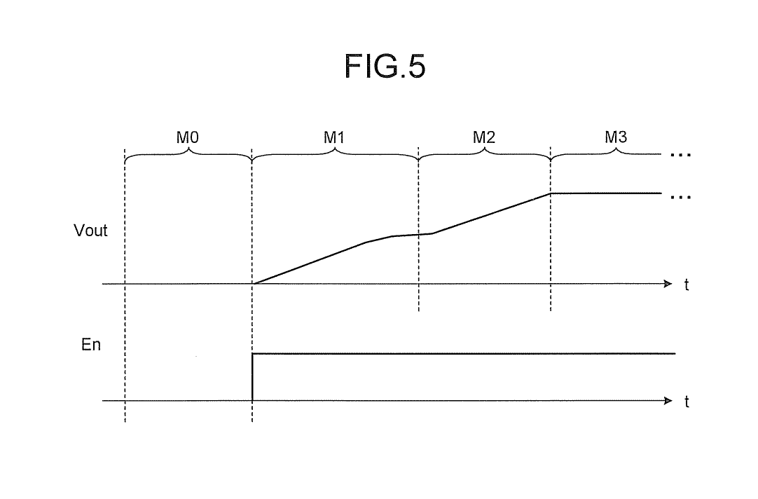

FIG. 5 is a diagram of a change in the output voltage Vout during the start of the DC/DC converter shown in FIG. 4.

In FIG. 5, in a mode M0 before the start of the DC/DC converter, an enable signal En is at a low level and the output voltage Vout is 0.

When the DC/DC converter is started, the enable signal En changes to a high level and the DC/DC converter shifts to a mode M1. In the mode M1, ON/OFF operations of the switching transistors M1 and M2 are stopped and the switch SW4 is turned on. The capacitor Cout is charged by the current source 21 until the input voltage Vin becomes equal to the output voltage Vout.

When the input voltage Vin becomes equal to the output voltage Vout, the DC/DC converter shifts to a mode M2. In the mode M2, the switch SW4 is turned off, whereby the charging of the capacitor Cout by the current source 21 is stopped. The soft-start control unit 2 controls the reference voltage VREF, whereby the output voltage Vout is gradually raised according to the ON/OFF operations of the switching transistors M1 and M2. When the output voltage Vout reaches a set voltage, the DC/DC converter shifts to a mode M3. In the mode M3, the reference voltage VREF is maintained at a fixed value. The output voltage Vout is maintained at a set voltage according to the ON/OFF operations of the switching transistors M1 and M2.

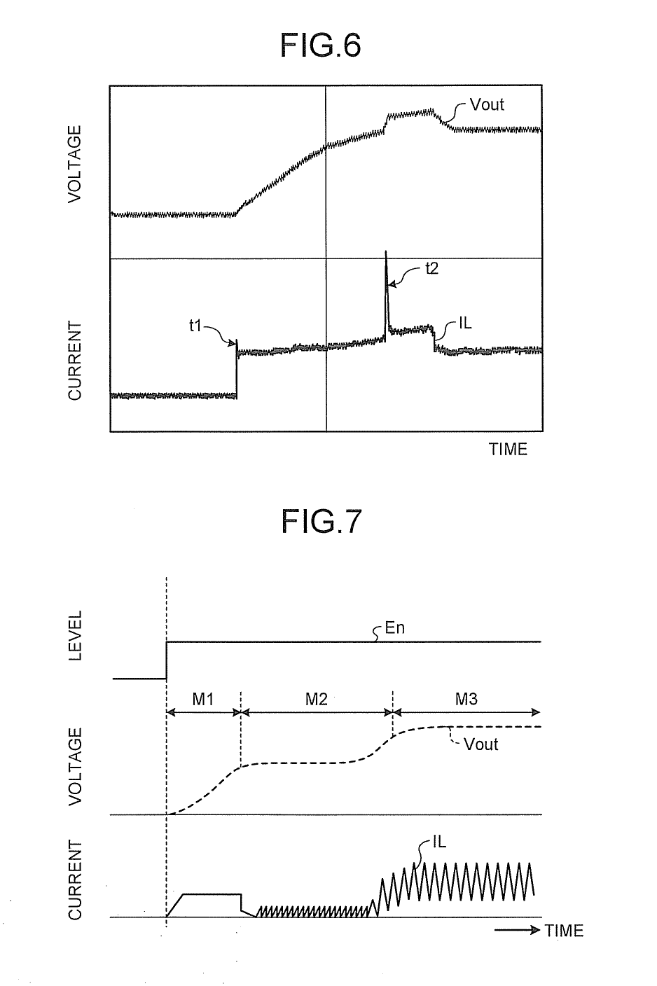

FIG. 6 is a diagram of waveforms of the output voltage Vout and the inductor current IL during the start of the DC/DC converter without a current source.

In FIG. 6, when the DC/DC converter does not include the current source 21 shown in FIG. 4, a rush current during the start (t1) is suppressed. However, during back gate switching (t2), a rush current of about 300 milliamperes instantaneously flows.

FIG. 7 is a diagram of waveforms of the output voltage Vout and the inductor current IL during the start of the DC/DC converter shown in FIG. 4.

In FIG. 7, the DC/DC converter shown in FIG. 4 is caused to operate according to a sequence shown in FIG. 5, whereby a rush current can be suppressed to about 100 milliamperes throughout the entire operation.

In the embodiments shown in FIGS. 1 to 4, a discharge function can be provided in the DC/DC converter. The discharge function can be used for an application in which inconvenience occurs if the output voltage Vout remains when the DC/DC converter is disabled. In the discharge function, a switch that discharges charges accumulated in the capacitor Cout when the DC/DC converter is disabled can be provided.

Even when the discharge function is provided in the DC/DC converter, when the input voltage Vin is larger than the output voltage Vout, the back gate of the switching transistor M2 is connected to the drain side. This makes it possible to prevent a rush current from rushing into the capacitor Cout via the parasitic diode D2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A DC/DC converter that converts an input voltage into an output voltage, comprising:
a switching transistor that changes, based on ON/OFF operations, a direction of an electric current flowing to an inductor;
a gate driving unit that applies a driving voltage to a gate of the switching transistor; and
a power-supply switching unit that switches, based on a result of comparison of the input voltage and the output voltage, a voltage of a power supply that generates the driving voltage.

2. The DC/DC converter according to claim 1, wherein the power-supply switching unit switches, when the input voltage is larger than the output voltage, the power supply for the gate driving unit to the input voltage side and switches, when the output voltage is equal to or larger than the input voltage, the power supply for the gate driving unit to the output voltage side.

3. The DC/DC converter according to claim 1, wherein
the switching transistor includes:
a first switching transistor that increases an inductor current flowing to the inductor; and
a second switching transistor that reduces the inductor current flowing to the inductor, and
the gate driving unit drives the first switching transistor and the second switching transistor in a complementary manner each other.

4. The DC/DC converter according to claim 3, further comprising:
an error amplifier that outputs, based on a result of comparison of a reference voltage and the output voltage, an error signal;
an oscillator that generates a triangular wave signal; and
a comparator that compares the error signal and the triangular wave signal, wherein
the gate driving unit drives, based on a result of the comparison by the comparator, the first switching transistor and the second switching transistor in a complementary manner each other.

5. The DC/DC converter according to claim 4, wherein the gate driving unit turns on the first switching transistor and turns off the second switching transistor when the triangular wave signal is smaller than the error signal.

6. The DC/DC converter according to claim 1, further comprising a back-gate switching unit that switches, based on the result of the comparison of the input voltage and the output voltage, connection of back gates of the switching transistor to a source side or a drain side.

7. The DC/DC converter according to claim 6, wherein the back-gate switching unit switches the connection of the back gates of the switching transistor such that, when the input voltage is larger than the output voltage, the back gate of the second switching transistor is connected to the drain side and, when the output voltage is equal to or larger than the input voltage, the back gate of the second switching transistor is connected to the source side.

8. The DC/DC converter according to claim 1, further comprising:
a capacitor that holds the output voltage;
a current source that charges the capacitor; and
a switch that stops, based on the result of the comparison of the input voltage and the output voltage, charging of the capacitor by the current source.

9. The DC/DC converter according to claim 8, wherein
the switch is turned on when the input voltage is larger than the output voltage, and
the switch is turned off when the output voltage is equal to or larger than the input voltage.

10. The DC/DC converter according to claim 1, further comprising a soft-start control unit that controls, based on the result of the comparison of the input voltage and the output voltage, an ON period of the switching transistor to thereby control a rising edge of the output voltage.

11. The DC/DC converter according to claim 9, wherein the soft-start control unit stops the ON/OFF operations of the switching transistor when the input voltage is larger than the output voltage.

12. A DC/DC converter that converts an input voltage into an output voltage, comprising:
a switching transistor that changes, based on ON/OFF operations, a direction of an electric current flowing to an inductor;
an inverter that applies a driving voltage to a gate of the switching transistor; and
a power-supply switching unit that switches, based on a result of comparison of the input voltage and the output voltage, a voltage of a power supply for the inverter.

13. The DC/DC converter according to claim 12, further comprising a level shifter that level-shifts an input signal of the inverter.

14. The DC/DC converter according to claim 13, wherein the power-supply switching unit switches, when the input voltage is larger than the output voltage, the power supply for the inverter and the level shifter to the input voltage side and switches, when the output voltage is equal to or larger than the input voltage, the power supply for the inverter and the level shifter to the output voltage side.

15. The DC/DC converter according to claim 14, wherein the switching transistor includes:
a first switching transistor that increases an inductor current flowing to the inductor; and
a second switching transistor that reduces the inductor current flowing to the inductor.

16. The DC/DC converter according to claim 15, further comprising:
an error amplifier that outputs, based on a result of comparison of a reference voltage and the output voltage, an error signal;
a comparator that compares a detected value of the inductor current flowing to the inductor and the error signal;
an oscillator that generates a pulse signal; and
a logic circuit that switches, based on a result of the comparison by the comparator, ON and OFF of the first and second switching transistors in a complementary manner each other in synchronization with the pulse signal.

17. The DC/DC converter according to claim 16, wherein the logic circuit turns on the first switching transistor and turns off the second switching transistor when the detected value of the inductor current is smaller than the error signal.

18. The DC/DC converter according to claim 17, further comprising a back-gate switching unit that switches, based on the result of the comparison of the input voltage and the output voltage, connection of a back gate of the second switching transistor to a source side or a drain side.

19. The DC/DC converter according to claim 18, wherein the back-gate switching unit switches the connection of the back gates of the switching transistor such that, when the input voltage is larger than the output voltage, the back gate of the second switching transistor is connected to the drain side and, when the output voltage is equal to or larger than the input voltage, the back gate of the second switching transistor is connected to the source side.

20. The DC/DC converter according to claim 12, further comprising:
a capacitor that holds the output voltage;
a current source that charges the capacitor; and
a switch that stops, based on the result of the comparison of the input voltage and the output voltage, charging of the capacitor by the current source.
